(19) United States
(12) Patent Application Publication
(10) Pub. No.: US 2025/0326340 A1
(43) Pub. Date: Oct. 23, 2025

(54) TEAR-STITCH WITH DRIVING MEMBER FOR TETHER OF CAR SEAT

(71) Applicant: WONDERLAND SWITZERLAND AG, Steinhausen (CH)

(72) Inventors: Kyle S. Mason, Lititz, PA (US); Curtis M. Hartenstine, Birdsboro, PA (US); David A. Lehman, Lancaster, PA (US)

(21) Appl. No.: 18/982,682

(22) Filed: Dec. 16, 2024

Related U.S. Application Data
(60) Provisional application No. 63/637,095, filed on Apr. 22, 2024.
(60) Provisional application No. 63/686,431, filed on Aug. 23, 2024.

(51) Int. Cl. B60N 2/28

(52) U.S. Cl. CPC B60N 2/2893; B60N 2/2821

(57) ABSTRACT

A child safety seat includes a child seat and a tether assembly operably coupled to the child seat. The tether assembly is connectable to a vehicle seat anchor and includes a tether strap having at least one breakaway feature and a driving member operably coupled to the tether strap. The at least one breakaway feature is configured to break before a material of the tether strap and the driving member is movable to break the at least one breakaway feature when the tether strap is tensioned.

### CROSS REFERENCE TO RELATED APPLICATIONS

This application is a non-provisional which claims the benefit of U.S. Provisional Patent Application No. 63/686,431, filed Aug. 23, 2024, and U.S. Provisional Patent Application No. 63/637,095, filed Apr. 22, 2024, each of which are incorporated by reference in their entirety herein.

### FIELD

Embodiments of the present disclosure relate to the art of child restraint systems for use in a vehicle.

### BACKGROUND

A child restraint system is designed to protect a child from injury or death during a collision of a vehicle. Existing child restraint systems commonly include a base portion and a seat portion detachably installed on the base portion. A child restraint system may be secured on a vehicle by a lower anchor and/or tether strap.

### BRIEF DESCRIPTION

According to an embodiment, a child safety seat includes a child seat and a tether assembly operably coupled to the child seat. The tether assembly is connectable to a vehicle seat anchor and includes a tether strap having at least one breakaway feature and a driving member operably coupled to the tether strap. The at least one breakaway feature is configured to break before a material of the tether strap and the driving member is movable to break the at least one breakaway feature when the tether strap is tensioned.

In addition to one or more of the features described above, or as an alternative, in further embodiments the at least one breakaway feature includes a plurality of breakaway features.

In addition to one or more of the features described above, or as an alternative, in further embodiments the plurality of breakaway features are spaced apart over a length of the tether strap.

In addition to one or more of the features described above, or as an alternative, in further embodiments the at least one breakaway feature is arranged at a folded portion of the tether strap.

In addition to one or more of the features described above, or as an alternative, in further embodiments the at least one breakaway feature connects an overlapping first portion of the tether strap and second portion of the tether strap at the folded portion.

In addition to one or more of the features described above, or as an alternative, in further embodiments the at least one breakaway feature includes a stitch line.

In addition to one or more of the features described above, or as an alternative, in further embodiments the stitch line extends transversely to the tether strap.

In addition to one or more of the features described above, or as an alternative, in further embodiments the folded portion of the tether strap includes a first portion positioned in overlapping arrangement with a second portion. The first portion is affixed to the second portion at a loop location and a loop extends between a fold formed in the tether strap and the loop location.

In addition to one or more of the features described above, or as an alternative, in further embodiments the at least one breakaway feature is formed at the folded portion, between the loop location and the fold.

In addition to one or more of the features described above, or as an alternative, in further embodiments the driving member is operably coupled to the tether strap between the loop location and the at least one breakaway feature.

In addition to one or more of the features described above, or as an alternative, in further embodiments the driving member is wedge shaped and a narrow end of the driving member is positioned near the at least one breakaway feature.

In addition to one or more of the features described above, or as an alternative, in further embodiments a length of the tether strap is adjustable separate from the at least one breakaway feature.

In addition to one or more of the features described above, or as an alternative, in further embodiments the tether assembly includes an adjuster block coupled to the tether strap. The tether strap is movable relative to the adjuster block to adjust the length of the tether strap.

In addition to one or more of the features described above, or as an alternative, in further embodiments the driving member is rigidly affixed to the adjuster block.

In addition to one or more of the features described above, or as an alternative, in further embodiments the driving member is a sharpened edge of the adjuster block.

In addition to one or more of the features described above, or as an alternative, in further embodiments a tether anchor arranged at an end of the tether strap, the tether anchor being connectable to the vehicle seat anchor.

In addition to one or more of the features described above, or as an alternative, in further embodiments the tether assembly includes another tether strap operably coupled to the tether strap via an adjuster block.

In addition to one or more of the features described above, or as an alternative, in further embodiments the another tether strap is movable relative to the adjuster block to adjust a length of the another tether strap.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The following descriptions should not be considered limiting in any way. With reference to the accompanying drawings, like elements are numbered alike:

FIG. 1A is a perspective view of a child safety seat according to an embodiment;

FIG. 1B is a side view of a child safety seat mounted to a vehicle seat according to an embodiment;

FIG. 2 is a perspective view of a portion of a tether assembly according to an embodiment;

FIG. 3 is a cross-sectional view of a portion of a tether assembly according to an embodiment;

FIG. 4 is a bottom perspective view of a portion of a tether assembly according to an embodiment; and

FIG. 5 is a perspective view of a tether assembly after several breakaway features of the tether assembly have been destroyed according to an embodiment.

### DETAILED DESCRIPTION

A detailed description of one or more embodiments of the disclosed apparatus and method are presented herein by way of exemplification and not limitation with reference to the Figures.

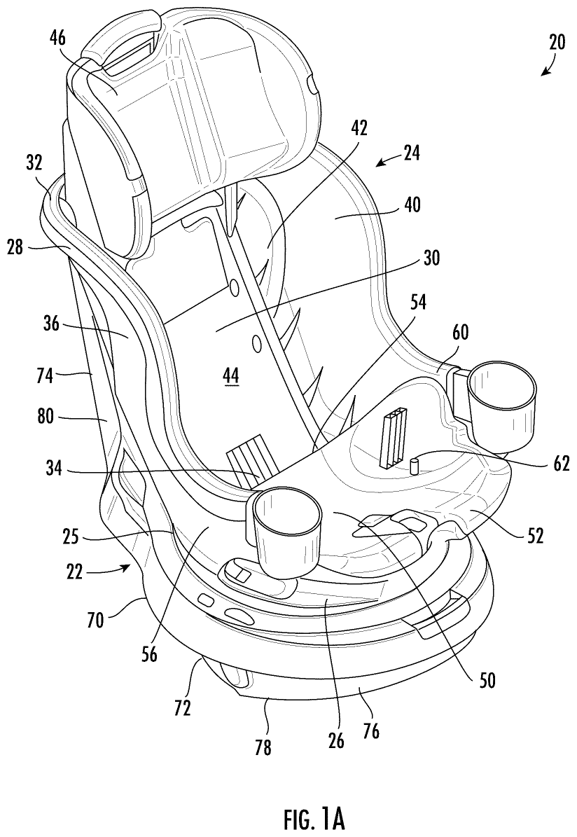

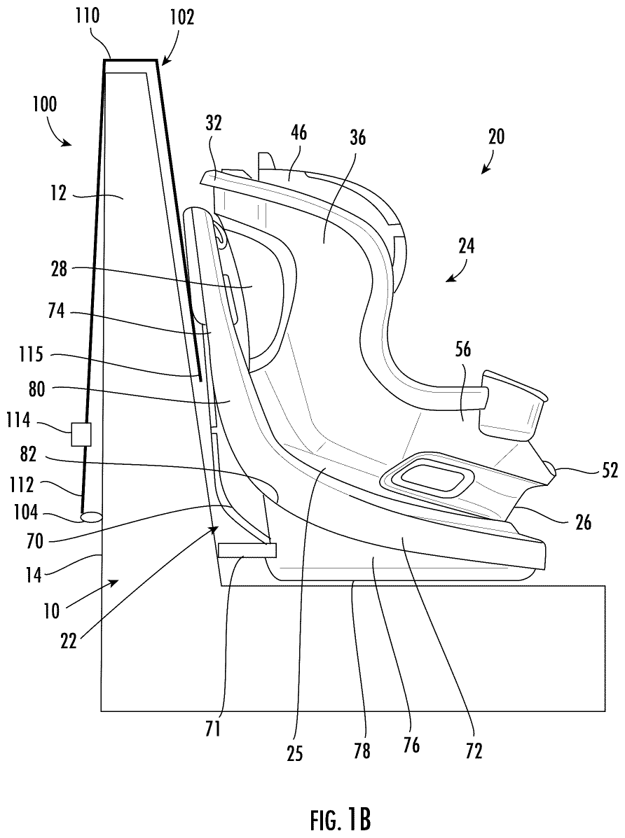

With reference now to the FIGS. 1A and 1B, an example of a child seat system is illustrated. As shown, the child safety seat 20 includes a support base 22 and a child seat 24. The child seat 24 may include a seat shell 25 having a seat portion 26 and a seat back or upright portion 28 arranged at an angle relative to the seat portion 26. The seat portion 26 and the seat back portion 28 may be detachably coupled, or alternatively, may be permanently coupled. In the illustrated, non-limiting embodiment, the seat portion 26 and the seat back portion 28 are integrally formed as a single unitary body.

As shown, the upright portion 28 of the child seat 24 includes an upright support surface 30 generally facing forward and that extends from a first end or top 32 to a second, opposite end or bottom 34 of the upright portion 28. A first upright side member 36 may be arranged at a first side (not shown) of the upright support surface 30, and a second upright side member 40 may be arranged at a second, opposite side 42 of the upright support surface 30. The first and second upright side members 36, 40 therefore form the left side and the right side of the upright portion 28, respectively. As shown, the first and second upright side members 36, 40 extend forward from the upright support surface 30. The first and second upright side members 36, 40 may extend generally orthogonally to the upright support surface 30 or alternatively, may extend therefrom at another angle, such as an angle greater than 90° for example. Accordingly, the upright support surface 30 and the first and second upright side members 36, 40 define a backrest region or upright support cavity 44 within which an upper body of a child is received.

In the illustrated, non-limiting embodiment, the seat back portion 28 of the child seat 24 includes a headrest 46. The headrest 46 is attached to or integral with the seat back portion 28. The headrest 46 may be stationary or in some embodiments, may be configured to move relative to the upright support surface 30. For example, the headrest 46 may be configured to translate relative to the upright support surface 30 between a retracted position and an extended position, allowing for adjustment based on the size of the child positioned within the child seat 24.

The seat portion 26 of the seat shell 25 includes a seat support surface 50 facing generally upwardly and that extends from a first end or front 52 to a second end or back 54 of the seat portion 26. A first seat side member 56 may be arranged at a first side (not shown) of the seat support surface 50 and a second seat side member 60 may be arranged at a second, opposite side 62 of the seat support surface 50. The first seat side member 56 and the second seat side member 60 extend upwardly and from the left side and the right side of the seat portion. The seat support surface 50 and the first and second seat side members 56, 60 in combination define a region 64 within which at least part of a lower body of a child may be received.

As shown, the first and second seat side members 56, 60 extend at an angle from the seat support surface 50. The angle of the first seat side member 56 relative to the seat support surface 50 may but need not be the same as the angle of the first upright side member 36 relative to the upright support surface 30. Similarly, the angle of the second seat side member 60 relative to the seat support surface 50 may but need not be the same as the angle of the second upright side member 40 relative to the upright support surface 30. In an embodiment, the first upright side member 36 and the first seat side member 56 are integrally formed and the second upright side member 40 and the second seat side member 60 are integrally formed.

The support base 22 is configured to receive and support a child seat, such as child seat 24 for example. The child seat 24 may be permanently coupled to the support base 22 or alternatively, may be removably connectable thereto. As used herein the term “permanently coupled” represents embodiments where the child seat 24 is not intended to be disassembled from the support base 22 by a user. In an embodiment, the support base 22 includes base body 70 having a base seat portion 72 positionable on a vehicle seat surface and a base back portion 74 positionable adjacent to or in contact with a vehicle seat back. Suitable materials for making the base body 70 include but are not limited to rigid plastic or composite materials for example. The base seat portion 72 and the base back portion 74 may be integrally formed as a unitary body, or alternatively, may be formed by separate components removably or permanently connected together.

With continued reference to FIGS. 1A-1B, in the illustrated, non-limiting embodiment, the support base 22 includes a first base member 76 having a bottom surface 78 suitable for placement on a support surface, such as a vehicle seat 10 for example, and a second base member 80 coupled to the first base member 76. In the illustrated, non-limiting embodiment, at least a portion of the second base member 80 is positioned in overlapping arrangement with an upper surface 82 (FIG. 1B) of the first base member 76. In the embodiments shown, the base back portion 74 of the support base 22 is formed solely by the second base member 80, and the base seat portion 72 of the support base 22 is formed by the first base member 76 and the second base member 80, in combination.

The support base 22 can be detachably fixed to a vehicle seat 10 (see FIG. 1B), such as via a latch or anchor mechanism 71. This latch or anchor mechanism 71 often used is sometimes referred to as a “lower anchor and tether for children” e.g., LATCH system. Alternatively, or in addition, the support base 22 may be detachably fixed to a vehicle seat 10 via a vehicle belt associated with the vehicle seat.

In some embodiments, the child safety seat 20 includes a tether assembly 100 connectable to a vehicle seat anchor to secure the child safety seat 20 relative to the vehicle seat 10. The tether assembly 100 may be used when the child safety seat 20 is arranged in a forward-facing configuration. The tether assembly 100 may but need not be used in combination with the latch and/or anchor mechanism 71 (and/or vehicle belt). In the illustrated, non-limiting embodiment, the tether assembly 100 is mounted to the support base 22, such as to the base back portion 74 thereof for example. In such embodiments, the tether assembly 100 may be considered operably coupled to a child seat 24 coupled to the support base 22. However, embodiments where the tether assembly 100 is connected to another location of the support base 22, or alternatively, is directly connected to the child seat 24, such as to the seat back 28 of the seat shell 25 for example, are also contemplated herein. The tether assembly 100 includes a tether strap 102 and a tether anchor 104 or other fastener arranged at the distal end of the tether assembly 100. As shown in FIG. 1B, the tether strap 102 is extendable over a top of the vehicle seat 10 and down a back side 14 of the vehicle seat back 12 to a vehicle anchor location engageable by the tether anchor 104.

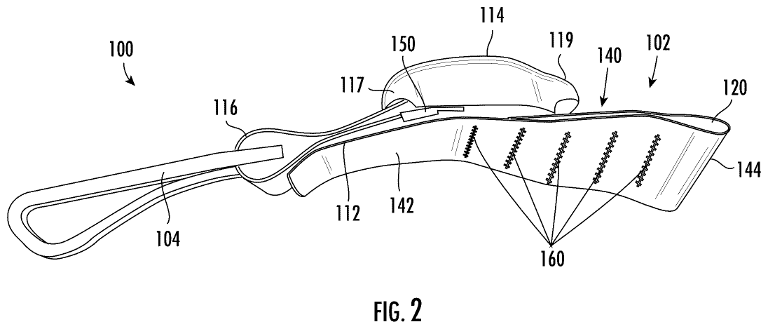

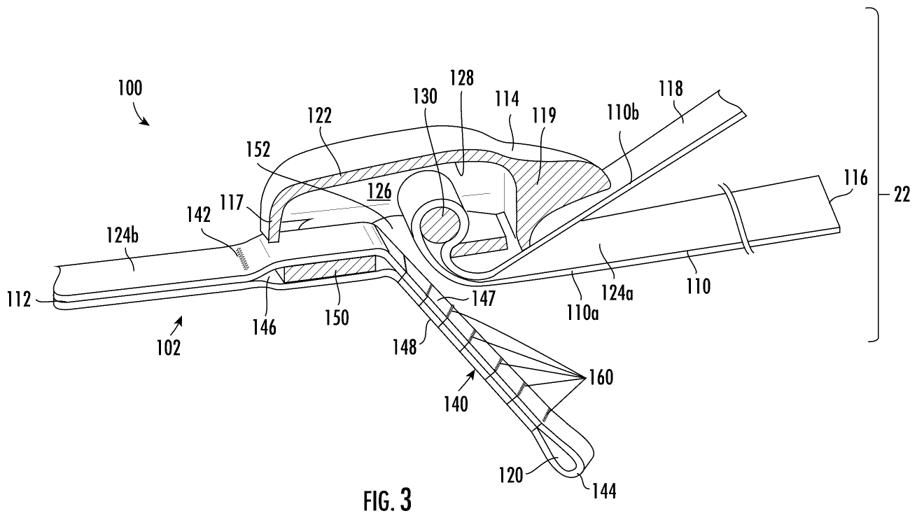

With continued reference to FIGS. 1A-1B and further reference to FIGS. 2-5, a portion of the tether assembly 100 of the child restraint system according to an embodiment is illustrated in more detail. In the illustrated, non-limiting embodiment, the tether strap 102 includes a first tether strap 110 and a second tether strap 112 operably coupled by an adjuster block 114. As will be described in more detail below, in an exemplary embodiment, at least one of the first tether strap 110 and the second tether strap 112 is movable relative to the adjuster block 114 to adjust an overall length of the tether assembly 100.

A first end 115 of the first tether strap 110 may be connected to the support base 22 to affix the tether assembly 100 to the child safety seat 20. The tether anchor 104 or other fastener attachable to the vehicle seat anchor may be arranged at the first end 116 of the second tether strap 112. In the illustrated, non-limiting embodiment, the adjuster block 114 is operatively connected to an intermediate portion of the first tether strap 110 and is connected to the second tether strap 112 at a location near a second end 120 thereof. As shown, the adjuster block 114 includes a housing 122 positionable in overlapping arrangement with a surface 124a, 124b such as an upper surface of a both the first tether strap 110 and the second tether strap 112. The housing 122 of the adjuster block 114 may be contoured such that an interior cavity 126 is generally defined between an interior surface 128 of the housing 122 and the first surface 124a, 124b of the first and second tether straps 110, 112.

In an embodiment, a base anchor 130 is arranged within the interior cavity 126 of the adjuster block 114, and the first tether strap 110 is connectable to the base anchor 130 to couple the first tether strap 110 to the adjuster block 114. As shown, the base anchor 130 may be a post extending at a non-parallel angle from a surface of the housing 122. However, it should be understood that embodiments where the base anchor 130 and/or the housing 122 of the adjuster block 114 have another configuration are also within the scope of the disclosure.

In the illustrated, non-limiting embodiment, the first tether strap 110 is configured to wrap about the base anchor 130 to couple the first tether strap 110 thereto. As shown, the first tether strap 110 may enter and exit the interior cavity 126 of the housing 122 at the same location. In such embodiments, a second portion 110b of the first tether strap 110 is positioned in overlapping arrangement with the upper surface 124a of a first portion 110a of the first tether strap 110 directly adjacent to the adjuster block 114. When the first tether strap 110 is wrapped about the base anchor 130 as described, the first tether strap 110 is movable relative to the adjuster block 114, such as by applying a force to the second portion 110b of the first tether strap 110, including the second end 118 of the first tether strap 110. This movement of the adjuster block 114 may be used to extend or retract the tether assembly 100 to tension the tether assembly connected to a vehicle seat anchor. Application of a force to the free second end 118 of the first tether strap 110 in a direction away from the adjuster block 114 will decrease the length of the first tether strap 110 extending between the first end 116 thereof and the base anchor 130. Similarly, applying a force to the adjuster block 114 in a direction away from the support base 22 will increase the length of the first tether strap 110 extending between the first end 116 thereof and the base anchor 130.

In the illustrated, non-limiting embodiment, the second tether strap 112 includes a folded portion or loop proximate to the second end 120 of the second tether strap 112. To form the loop 140, a portion of the second tether strap 112 is folded onto itself and the two overlapping layers of the second tether strap 112 are affixed to one another at a loop location 142 offset from the fold 144. Accordingly, the loop 140 extends between the loop location 142 and the fold 144 of the second tether strap 112. To form the loop 140, the two overlapping layers of the second tether strap 112 may be stitched together, may be adhered together via an adhesive, or may be connected in any other suitable manner at the loop location 142.

As shown, a driving member 150 associated with the adjuster block 114 is associable with the second tether strap 112, to couple the adjuster block 114 to the second tether strap 112. The driving member 150 may initially engage the second tether strap 112 near the loop location 142. In an embodiment, the driving member 150 is receivable within the interior 146 of the loop 140 of the second tether strap 112. One of the edges of the driving member 150, such as the edge furthest from the loop location 142 for example, may have a sharpened or pointed edge. The driving member 150 is rigidly coupled to the adjuster block 114, and in some embodiments may be integrally formed with or may be part of the adjuster block 114. For example, the driving member 150 may be formed by sharpening an edge of the adjuster block 114 configured to interact with the second tether strap 112. In an aspect, the driving member 150 can have an approximate wedge shape. The approximate wedge shape can be positioned such that a narrow end of the wedge shape is furthest from the loop location 142. In such embodiments, the narrow end may be configured to interact with the portion of the loop 140 extending toward the second end 144, such as a second portion 148 of the second tether strap 112 or at least one breakaway feature 160 as will be described in more detail below.

The driving member 150 may be positioned near a front 117 of the adjuster block 114. Although the driving member 150 is shown positioned vertically beneath the base anchor 130, such as at a location vertically underneath the upper surface 124b of the second tether strap 112, embodiments where the driving member 150 and the base anchor 130 are coplanar, and embodiments where the base anchor 130 is positioned vertically beneath the driving member 150 are also contemplated herein. The driving member 150 may be formed from any suitable material, such as metal or plastic for example. In the illustrated, non-limiting embodiment, the driving member 150 is a plate having an opening 152 formed therein. In such embodiments the first tether strap 110 may extend though the opening 152 formed in the driving member 150 to access the interior cavity 126 of the housing 122 and couple to the base anchor 130. The rear portion of the plate 150 extending from the opening 152 towards a back 119 of the adjuster block 114 is positioned above the overlapped first and second portions 110a, 110b of the first tether strap 110. Accordingly, the rear portion of the plate 150 may be arranged within the interior cavity 126 while the front portion of the plate 150, extending between the opening 152 and the front 117 of the adjuster block 114, is located outside of the interior cavity 126.

The connection between the second tether strap 112 and the adjuster block 114 may be designed to allow movement of the adjuster block 114 relative to the second tether strap 112 when the second tether strap 112 is tensioned and a force acting on the adjuster block 114, and therefore the driving member 150, exceeds a predetermined, desired threshold. In an embodiment, the second end 120 of the second tether strap 112 includes at least one breakaway feature 160. The at least one breakaway feature 160 may be designed such that the force required to destroy or overcome the breakaway feature 160 is less than the force required to break the material of the tether strap 112. In such embodiments, the at least one breakaway feature 160 will give way before the tether strap breaks.

The at least one breakaway feature 160 is located at the loop 140 at a position between the loop location 142 and the fold 144. In an exemplary embodiment, the driving member 150 may initially be coupled to the second tether strap 112 via insertion into the loop 140 at a location between the loop location 142 and the breakaway feature 160 located closest to the loop location 142. For example, the driving member 150 may be received within the loop 140 at a location directly adjacent to the loop location 142. In the illustrated, non-limiting embodiment, the at least one breakaway feature 160 includes a plurality of breakaway features positioned between the driving member 150 and the fold 144. Although five breakaway features 160 are illustrated in the FIGS. it should be understood that a tether strap may include a single breakaway feature, two breakaway features, three breakaway features, four breakaway features, or six or more breakaway features. In embodiments including a plurality of breakaway features 160, the plurality of breakaway features may be evenly spaced, or alternatively, may be positioned at varying intervals. Further, the force required to overcome, destroy, or tear each breakaway feature 160 may be the same, or alternatively, may vary.

A first portion 147 of the second tether strap 112 extends between the fold 144 and the loop location 142 and forms an upper portion of the loop 140. Similarly, a second portion 148 of the second tether strap 112 extends between the fold 144 and the loop location 142 to form a lower portion of the loop 140. The at least one breakaway feature 160 defines an interface or connection between the first portion 147 and the second portion 148 of the second tether strap 112 at one or more locations between the fold 144 and the loop location 142. Such a connection may be formed in any suitable manner. For example, in an embodiment, a breakaway feature 160 includes one or more stitches, such as arranged in a stitch line, connecting the first portion 147 and the second portion 148 together. Although the stitch line 160 is illustrated as being transverse to the tether strap 112, embodiments including a stitch line at another orientation, or alternatively, including a plurality of overlapping stitch lines are also contemplated herein. In another embodiment, glue or another adhesive may be positioned between adjacent surfaces of the first and second portions 147, 148 at one or more locations to form at least one breakaway feature 160.

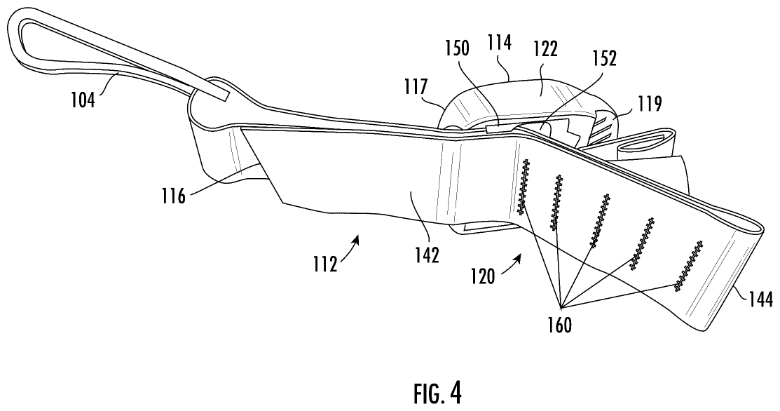

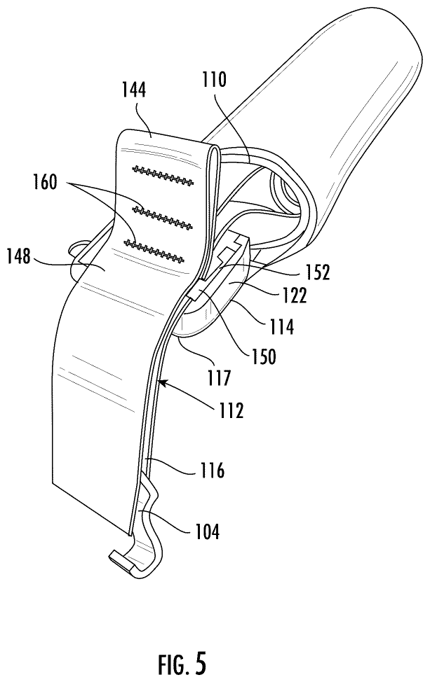

With reference to FIGS. 4 and 5, during a frontal crash event, a force may act on the child safety seat 20 in a direction away from the vehicle seat back 12. The connection between the first tether strap 110 and the adjuster block 114 transmits the force from the first tether strap 110 to the adjuster block 114. The force acting on the adjuster block 114 will move the driving member 150 into engagement with the at least one breakaway feature 160.

If the magnitude of the force acting on the driving member 150 exceeds the threshold of the at least one breakaway feature 160, the driving member 150 will break the at least one breakaway feature 160, allowing the driving member 150, and therefore the adjuster block 114, first tether strap 110, and support base 22 connected thereto, to move relative to the second tether strap 112 (e.g. through the at least one breakaway feature in a direction of the force). When the breakaway feature 160 includes one or more stitches, the force applied thereto by the driving member 150 causes the stitches to rip apart from one or both of the first and second portions 147, 148 of the second tether strap 112, thereby allowing the driving member to move between the first and second portions 147, 148 at the location of the breakaway features 160. In embodiments including a plurality of breakaway features 160, the breakaway features 160 are positioned to break sequentially. As a result, the child safety seat 20 is gradually movable forward away from the vehicle seat back 12, as each respective breakaway feature 160 is destroyed in response to an impact on the vehicle. Destruction of the one or more breakaway features 160 is configured to absorb some energy from the impact, thereby reducing overall movement of the child safety seat 20 and the force acting directly on the second tether strap 112. This absorption of energy increases as each successive breakaway feature is destroyed.

The term “about” is intended to include the degree of error associated with measurement of the particular quantity based upon the equipment available at the time of filing the application. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A child safety seat comprising:
a child seat;
a tether assembly operably coupled to the child seat, the tether assembly being connectable to a vehicle seat anchor, the tether assembly including:
a tether strap having at least one breakaway feature, the at least one breakaway feature being configured to break before a material of the tether strap; and
a driving member operably coupled to the tether strap, the driving member being movable to break the at least one breakaway feature when the tether strap is tensioned.

2. The child safety seat of claim 1, wherein the at least one breakaway feature includes a plurality of breakaway features.

3. The child safety seat of claim 2, wherein the plurality of breakaway features are spaced apart over a length of the tether strap.

4. The child safety seat of claim 1, wherein the at least one breakaway feature is arranged at a folded portion of the tether strap.

5. The child safety seat of claim 4, wherein the at least one breakaway feature connects an overlapping first portion of the tether strap and second portion of the tether strap at the folded portion.

6. The child safety seat of claim 4, wherein the at least one breakaway feature includes a stitch line.

7. The child safety seat of claim 6, wherein the stitch line extends transversely to the tether strap.

8. The child safety seat of claim 4, wherein the folded portion of the tether strap includes a first portion positioned in overlapping arrangement with a second portion, the first portion being affixed to the second portion at a loop location, a loop extends between a fold formed in the tether strap and the loop location.

9. The child safety seat of claim 8, wherein the at least one breakaway feature is formed at the folded portion, between the loop location and the fold.

10. The child safety seat of claim 9, wherein the driving member is operably coupled to the tether strap between the loop location and the at least one breakaway feature.

11. The child safety seat of claim 1, wherein the driving member is wedge shaped and a narrow end of the driving member is positioned near the at least one breakaway feature.

12. The child safety seat of claim 1, wherein a length of the tether strap is adjustable separate from the at least one breakaway feature.

13. The child safety seat of claim 12, wherein the tether assembly further comprises an adjuster block coupled to the tether strap, the tether strap being movable relative to the adjuster block to adjust the length of the tether strap.

14. The child safety seat of claim 13, wherein the driving member is rigidly affixed to the adjuster block.

15. The child safety seat of claim 14, wherein the driving member is a sharpened edge of the adjuster block.

16. The child safety seat of claim 1, further comprising a tether anchor arranged at an end of the tether strap, the tether anchor being connectable to the vehicle seat anchor.

17. The child safety seat of claim 1, where in the tether assembly further comprises another tether strap operably coupled to the tether strap via an adjuster block.

18. The child safety seat of claim 17, wherein the another tether strap is movable relative to the adjuster block to adjust a length of the another tether strap.
